(19) United States
(12) Patent Application Publication
(10) Pub. No.: US 2008/0082442 A1
(43) Pub. Date: Apr. 3, 2008

(54) CREDIT CARD MANAGEMENT METHOD USING COMMUNICATION TERMINAL

(75) Inventor: Jin Young CHON, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/858,041

(22) Filed: Sep. 19, 2007

(30) Foreign Application Priority Data
Oct. 2, 2006 (KR) 2006-0096900

(51) Int. Cl. G06Q 40/00

(52) U.S. Cl. 705/39

(57) ABSTRACT

A credit card management method using a communication terminal is disclosed. In a process of credit data transmission in the credit card management method, credit data of a credit card selected from a list of registered credit cards are transmitted to a personal computer through a local radio communication network. If a credit card is reported lost, the communication terminal is connected to a card security center to resolve the issue regarding the selected credit card. In the searching method for credit card usage information, the credit card usage information is searched by connecting to a home page of a credit card company corresponding to the selected credit card. According to the present invention, when shopping on-line, a user of a communication terminal may purchase a commodity easily. Further, the user may easily report a lost credit card or may search for credit card usage information.

### PRIORITY

This application claims priority to an application entitled “CREDIT CARD MANAGEMENT METHOD USING COMMUNICATION TERMINAL” filed in the Korean Intellectual Property Office on Oct. 2, 2006 and assigned Serial No. 2006-0096900, the contents of which are incorporated herein by reference.

### BACKGROUND OF THE INVENTION

1. Field of the Invention

The present invention relates to a credit card management method using a communication terminal, and more particularly, to a method for transmitting credit data of a credit card, reporting a lost credit card, and searching for credit card usage information.

2. Description of the Prior Art

Generally, recent communication terminals provide various functions, such as a phonebook, scheduler, memo, photographing, and replay of music and moving pictures, in addition to their basic function of telecommunication and thereby user reliance on the communication terminal is increasing.

With an increase in online shopping, credit cards are more frequently being used. The owner of a credit card may conveniently purchase a commodity through the Internet by inputting credit data, such as a card number, validity, and authenticated password of the credit card in a transaction window of a personal computer.

However, the credit card owner must input the credit data in the transaction window or must search for credit data pre-stored as a text file in a communication terminal and input the credit data in the transaction windows, whenever a purchase transaction by a credit card is performed.

In the case that the credit card is lost or stolen, the credit card owner must enter directly in the communication terminal the telephone number of the card security center of a credit card company or must search for the telephone number of the card security center pre-stored in a phonebook of the communication terminal and call up the card security center by using the found telephone number. Further, the credit card owner must input every item of credit data requested by the card security center.

In order to retrieve credit card usage information, such as a list of credit card usage, reward points, and credit limit, the credit card owner must search for a home page of the credit card company and connect to the home page by using a personal computer.

As described above, the credit card owner may be inconvenienced when receiving credit card services through a communication terminal.

### SUMMARY OF THE INVENTION

The present invention has been made in view of the above problems, and provides a method of registering and managing a plurality of credit cards in a communication terminal.

The present invention further provides a method of credit card management using a communication terminal for transmitting credit data from the communication terminal to a transaction window of a personal computer.

The present invention further provides a method of credit card management using a communication terminal for reporting a lost credit card.

The present invention further provides a method of credit card management using a communication terminal for searching for credit card usage information.

A method for credit card management using a communication terminal for transmitting credit data according to an exemplary embodiment of the present invention includes displaying a list of registered credit cards, if a credit data transmission is requested; displaying credit data of the selected credit card, if a credit card is selected from the displayed list of registered credit cards; and transmitting the displayed credit data to a personal computer through a local radio communication network.

A method for credit card management using a communication terminal for reporting a lost credit card according to another exemplary embodiment of the present invention includes displaying a list of registered credit cards, if a lost credit card report is requested; and connecting to a card security center for telephone conversation corresponding to the selected credit card, if a credit card is selected from the displayed list of registered credit cards.

A method of credit card management using a communication terminal for searching for credit card usage information according to another exemplary embodiment of the present invention includes displaying a list of registered credit cards, if a search for credit card usage information is requested; connecting to a home page of a credit card company corresponding to the selected credit card, if a credit card is selected from the displayed credit cards; and searching for the credit card usage information in the home page of the credit card company.

### BRIEF DESCRIPTION OF THE DRAWINGS

The objects, features and advantages of the present invention will become more apparent from the following detailed description in conjunction with the accompanying drawings, in which:

FIG. 1 is a system overview showing a configuration of a personal computer and a communication terminal connected through a Bluetooth network according to the present invention;

FIG. 2 is a block diagram showing a configuration of the personal computer and communication terminal of FIG. 1;

FIG. 3 is a flow chart of the process of registering a credit card in a communication terminal in a method of credit card management according to the present invention;

FIGS. 4A to 4C are screen examples displayed in the process of FIG. 3;

FIGS. 5A and 5B are a flow chart of a purchase transaction process in a communication terminal and a personal computer providing Bluetooth communication in a method of credit card management according to the present invention;

FIG. 6 is flow chart of a process of transmitting credit data in a communication terminal and a personal computer providing Bluetooth communication in a method of credit card management according to the present invention;

FIGS. 7A to 7C are screen examples displayed in the process of FIG. 6;

FIGS. 8A and 8B are flow charts of a process of reporting a lost credit card in a communication terminal in a method of credit card management according to the present invention;

FIGS. 9A to 9D are screen examples displayed in the process of FIGS. 8A and 8B;

FIG. 10 is a flow chart of a process of retrieving credit card usage information in a communication terminal in a method of credit card management according to the present invention; and

FIGS. 11A to 11C are screen examples displayed in the process of FIG. 10.

### DETAILED DESCRIPTION OF PREFERRED EMBODIMENTS

Hereinafter, exemplary embodiments of the present invention are described in detail with reference to the accompanying drawings.

In this specification, a “credit card” is used as a payment means for a purchase transaction, replacing a cash payment, and includes a deferred payment card, prepaid card, and debit card. “Credit data” is data stored in a credit card for identification of an owner of a credit card, such as a card number, validity, authenticated password, and personal identification number. “Credit card information” includes information obtainable from the credit card (i.e. credit data) and may further include a telephone number of a card security center and a home page address of a credit card company. “Credit card usage information” is obtained from the result of using the credit card and includes a list of credit card usage, reward points, and credit limit.

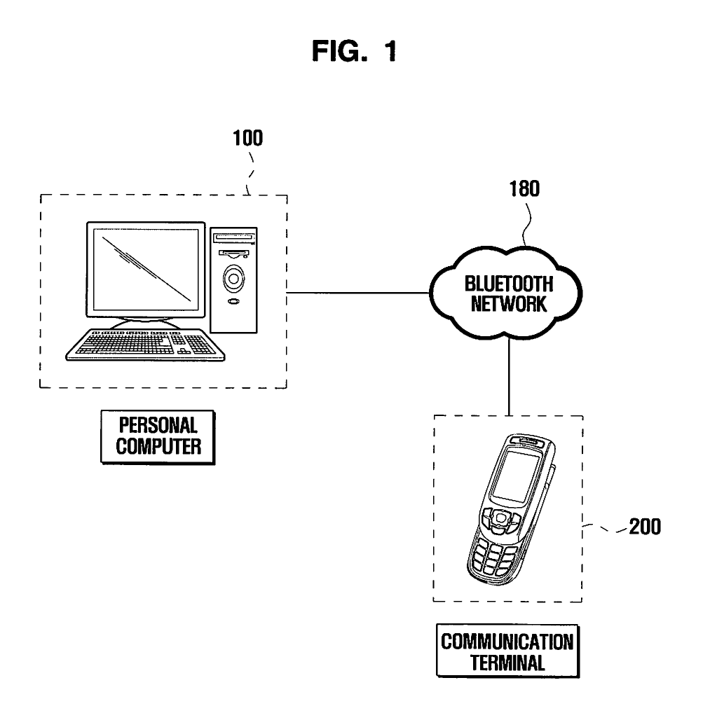

Referring to FIG. 1, communication terminal 200 is connected to personal computer (hereinafter, PC) 100 through a Bluetooth® (hereinafter Bluetooth)

network 180. PC 100 and communication terminal 200 exchange data and objects such as image data, vCard or vCalendar data, and sound data, through Bluetooth network 180. That is, communication terminal 200 may transmit data and objects to PC 100 and may download data and objects stored in PC 100 through Bluetooth network 180. In particular, communication terminal 200 can transmit credit data selected by a user from credit card information registered in communication terminal 200 to PC 100.

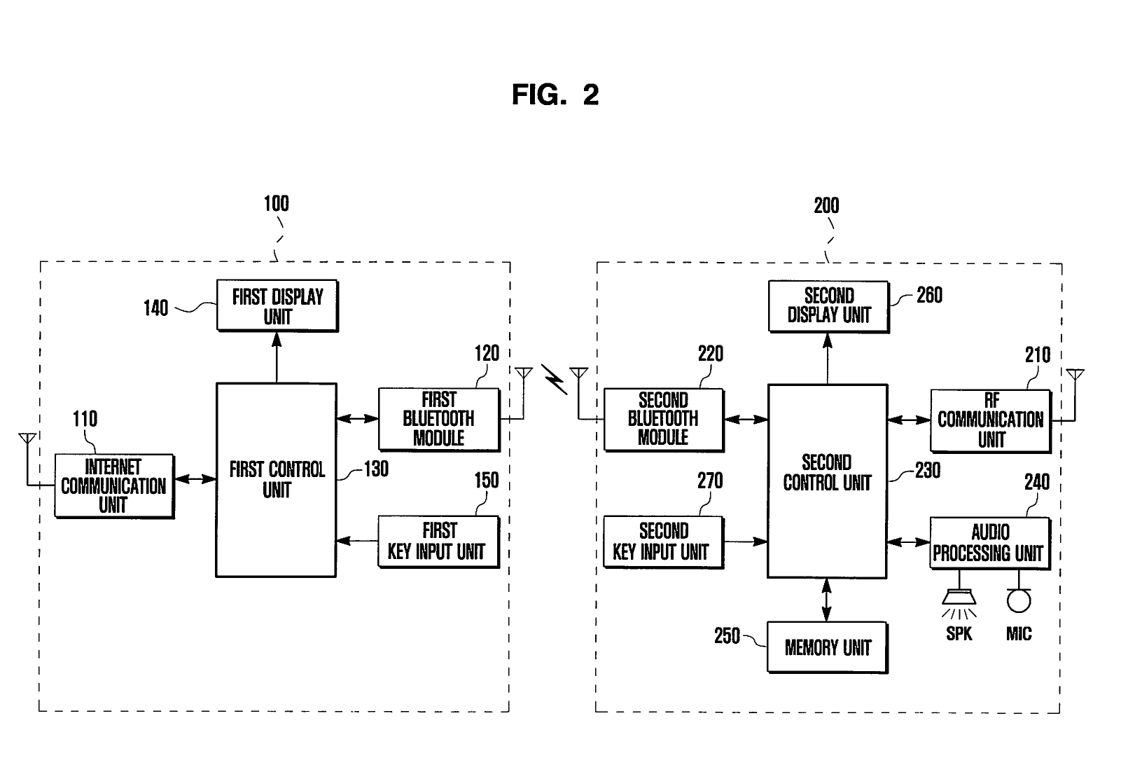

Referring to FIG. 2, PC 100 includes an Internet communication unit 110, first Bluetooth module 120, first control unit 130, first display unit 140, and first key input unit 150. The communication terminal 200 includes an RF (radio frequency) communication unit 210, second Bluetooth module 220, second control unit 230, audio processing unit 240, memory unit 250, second display unit 260, and second key input unit 270.

Internet communication unit 110 performs connection to a home page of a sales company through Internet.

First Bluetooth module 120 performs communication with communication terminal 200 and receives credit data from communication terminal 200.

First control unit 130 controls general operation of PC 100 and sets a Bluetooth communication link with communication terminal 200. First control unit 130 receives credit data from communication terminal 200 through first Bluetooth module 120 and processes the received credit data. Further, first control unit 130 controls such that the credit data is input in a predetermined position of a transaction window displayed on first display unit 140.

First display unit 140 displays the status of PC 100 according to the control of first control unit 130. First key input unit 150 includes alphanumeric keys for character input and function keys for setting various functions.

RF communication unit 210 performs radio communication of communication terminal 200. RF communication unit 210 includes an RF transmitter for up-converting the frequency of a signal to be transmitted and amplifying the signal, and an RF receiver for low noise amplifying a received signal and down-converting the frequency of the received signal. Additionally, RF communication unit 210 may connect to a home page of a credit card company through the Internet.

Second Bluetooth module 220 performs communication with PC 100 and transmits credit data to PC 100.

Second control unit 230 controls general operation of communication terminal 200 and manages credit card information. Second control unit 230 includes a data processing unit having a transmitter for encoding and modulating a signal to be transmitted and a receiver for demodulating and decoding a received signal. The data processing unit may be configured with a modem and a codec. In particular, second control unit 230 processes credit data selected from the credit card information and controls transmission of the processed credit data to PC 100 through second Bluetooth module 220. If a telephone number of a card security center is selected from the credit card information, second control unit 230 controls to call the card security center having the telephone number. If a home page address of a credit card company is selected from the credit card information, second control unit 230 controls to connect to the home page of the credit card company through Internet.

Audio processing unit 240 outputs an audio signal received from an audio CODEC of the data processing unit to a speaker SPK and outputs an audio signal received from a microphone MIC to an audio codec of the data processing unit.

Memory unit 250 includes a program memory and a data memory. The program memory stores programs for general operation of communication terminal 200, programs for credit card information management, and programs for Bluetooth communication. The data memory stores data generated during execution of the programs. Additionally, memory unit 250 stores credit card information registered by a user.

Second display unit 260 displays the status of communication terminal 200 according to the control of second control unit 230. Second display unit 260 may be configured with an LCD (liquid crystal display). In this case, second display unit 260 may include an LCD controller, memory for storing display data, and LCD device. If the LCD has a touch screen function, second display unit 260 may also be used as an input unit.

Second key input unit 270 includes alphanumeric keys for character input and function keys for setting various functions.

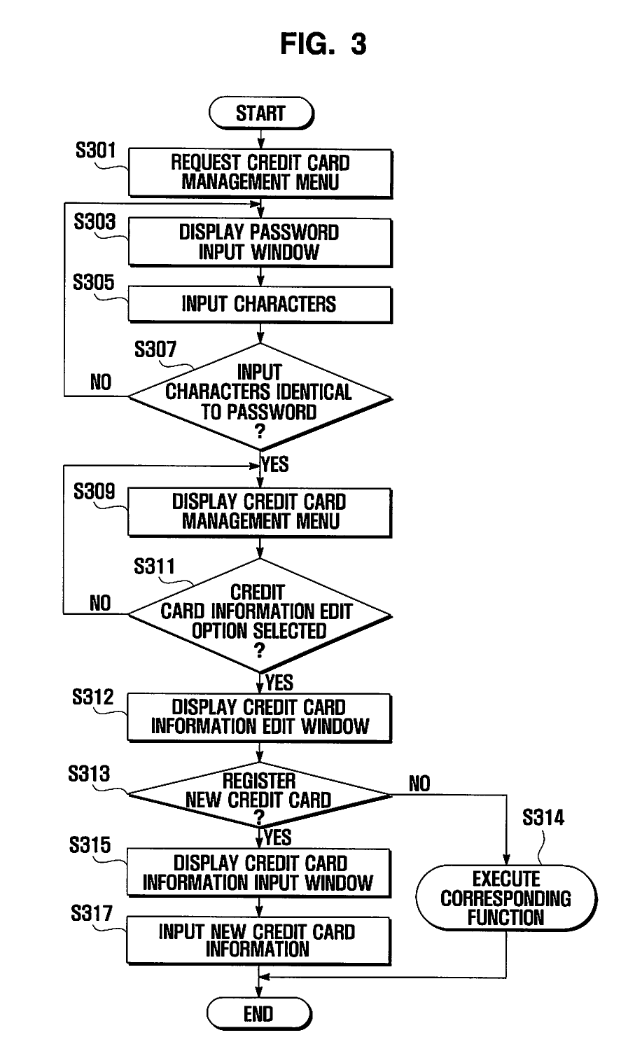

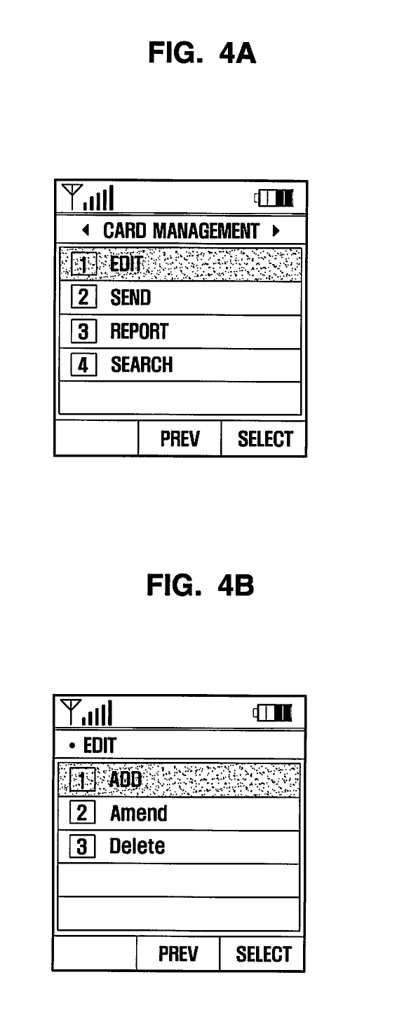

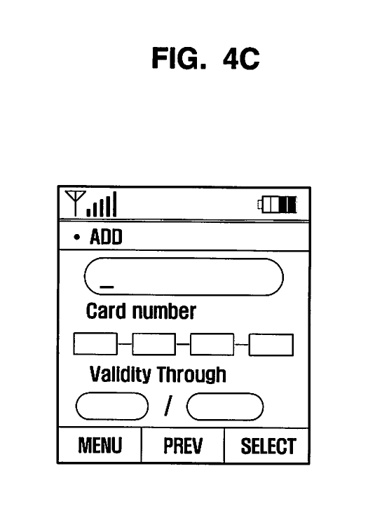

Referring to FIGS. 2, 3, and 4A to 4C, initial setting of credit card management function starts by inputting a function key (or shortcut key) of second key input unit 270 or by selecting an option of a credit card management menu in step S301. Second control unit 230 controls to display a password input window in step S303. Second control unit 230 then receives a alphanumeric characters input by a user in step S305 and identifies whether the input characters are identical to a registered password in step S307. If the input characters are identical to a registered password, second control unit 230 controls to display a credit card management menu, as shown in FIG. 4A in step S309.

If a credit card information edit option is selected from the credit card management menu in step S311, second control unit 230 controls to display a credit card information edit menu, as shown in FIG. 4B in step S312.

Lastly, if registration of a new credit card is requested in step S313, second control unit 230 controls to display a credit card information addition window, as shown in FIG. 4C in step S315. Second control unit 230 then registers new credit card information input by the user in step S317.

If registration of a new credit card is not requested at step S313, second control unit 230 executes a corresponding function, for example, amending or deleting pre-stored credit card information in step S314.

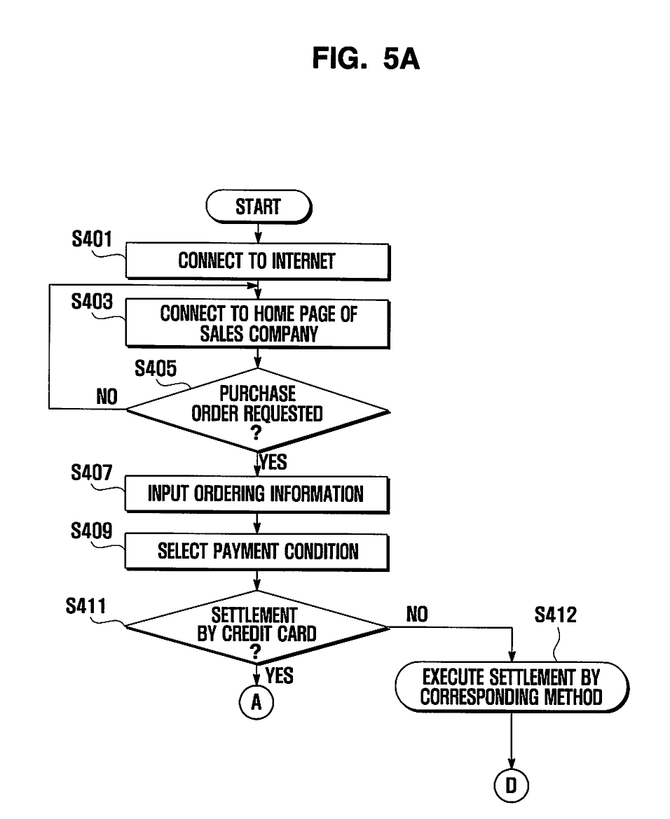

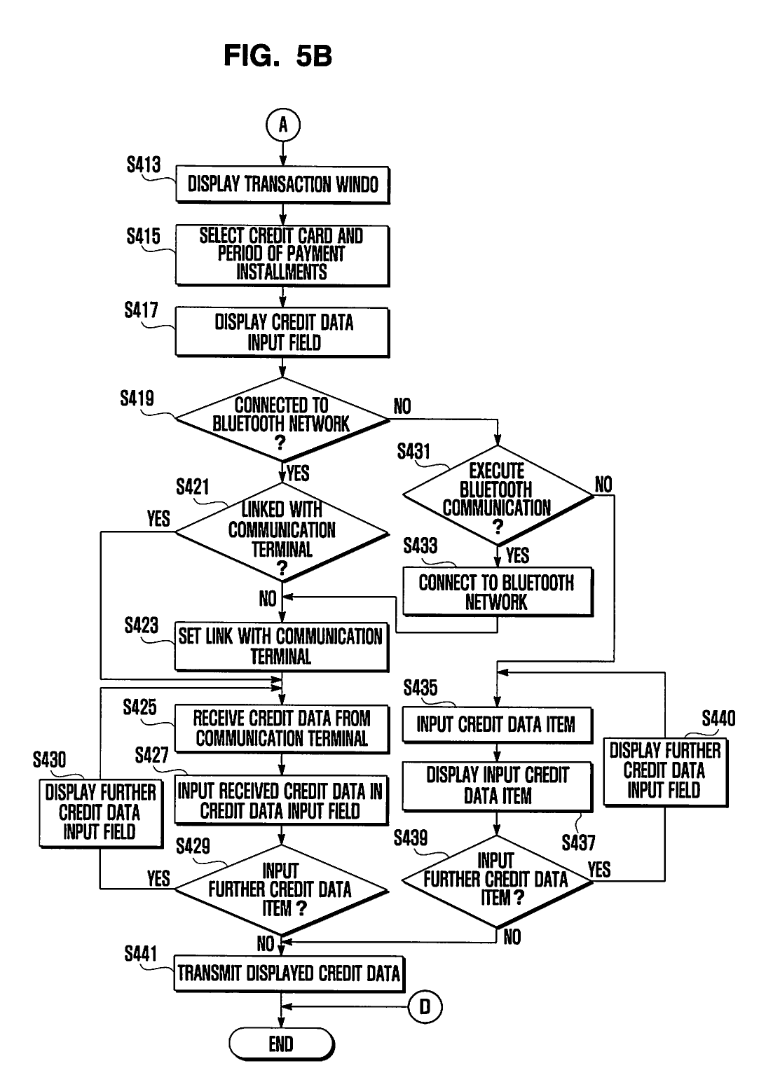

Referring to FIGS. 2 and 5, first control unit 130 connects PC 100 to Internet in step S401 and further to a home page of a sales company in step S403. If a purchase order is requested in step S405, first control unit 130 receives ordering information input by the user, such as an address of delivery and a contact telephone number in step S407. First control unit 130 then receives a payment condition selected by the user in step S409 and identifies whether the selected payment condition is a payment by a credit card in step 411. If the selected payment condition is not a payment by a credit card, first control unit 130 executes settlement according to another payment condition selected by the user in step S412 and terminates the process. If the selected payment condition is a payment by a credit card, first control unit 130 controls to display a transaction window for settlement by credit card in step S413.

First control unit 130 identifies a credit card for the settlement selected by the user and a period of payment installments input by the user through the transaction window in step S415, and controls to display a credit data input field in step S417. At this moment, first control unit 130 locates a cursor in the displayed credit data input field.

If PC 100 is connected to a Bluetooth network in step S419, first control unit 130 identifies whether a Bluetooth communication link is set between PC 100 and communication terminal 200 in step S421. If a Bluetooth communication link is not set between PC 100 and the communication terminal 200, first control unit 130 sets a Bluetooth communication link between PC 100 and communication terminal 200 in step S423. First control unit 130 then receives credit data from communication terminal 200 through first Bluetooth module 120 in step S425.

If a Bluetooth communication link is already set between PC 100 and communication terminal 200 at step S421, the process continues at step S425.

First control unit 130 inputs the received credit data in the credit data input field in which the cursor is located in step S427. First control unit 130 then identifies whether a further credit data input field exists in step S429. If a further credit data input field exists, first control unit 130 controls to display the further credit data input field and locates the cursor in the further credit data input field in step S430, then the process returns to step S425. First control unit 130 repeats steps S425 to S429 until all desired credit data input fields are completed.

If PC 100 is not connected to a Bluetooth network at step S419, first control unit 130 identifies if execution of Bluetooth communication is requested in step S431. If execution of Bluetooth communication is requested, first control unit 130 connects to a Bluetooth network in step S433 and continues at step S423.

If execution of Bluetooth communication is not requested at step 431, first control unit 130 receives credit data input through first key input unit 150 in step S435 and controls to display the received credit data in the displayed credit data input field in step S437. First control unit 130 then identifies if a further credit data input field exists in step S439. If a further credit data input field exists, first control unit 130 controls to display the further credit data input field in step S440, then returns to step S435, and repeats steps S435 to S439 until all desired credit data input fields are completed.

If no further credit data input field exists at step S429 or at step S439, the first control unit 130 transmits the credit data displayed in the credit data input fields to a server through the Internet communication unit 110 in step S441 and thereby completes the process of purchase transaction in PC 100.

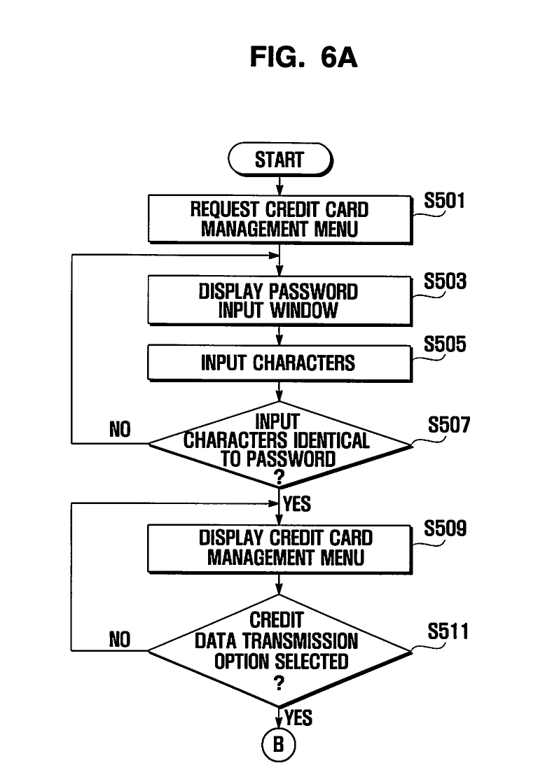

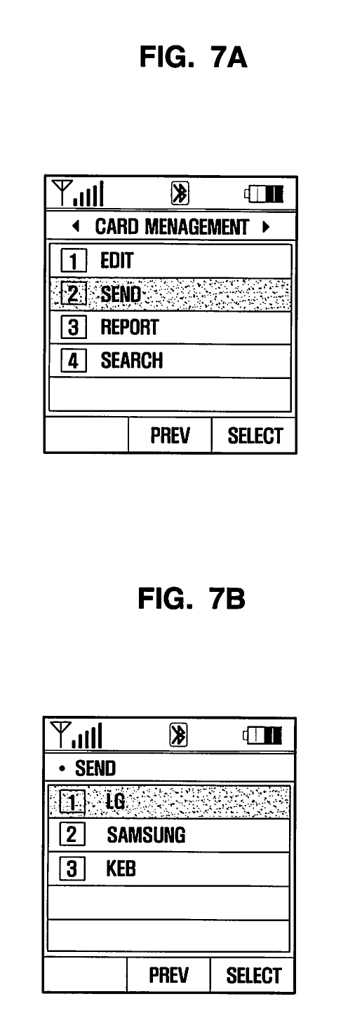

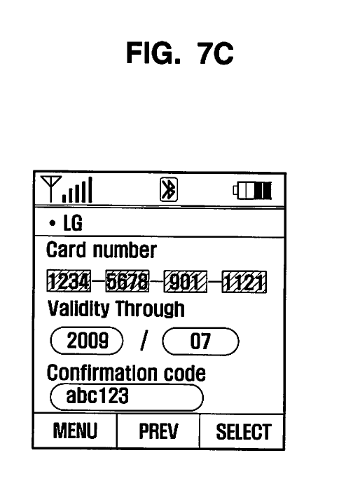

FIG Referring to FIGS. 2, 6, and 7A to 7C, the process of transmitting credit data starts by inputting a function key (or shortcut key) through second key input unit 270 or by selecting a credit card management option in step S501. Second control unit 230 controls to display a password input window in step S503. Second control unit 230 then receives alphanumeric characters input by a user in step S505 and identifies if the input characters are identical to a registered password in step S507. If the input characters are identical to the registered password, second control unit 230 controls to display a credit card management menu, as shown in FIG. 7A in step S509.

Subsequently, if a credit data transmission option is selected from the credit card management menu in step S511, second control unit 230 identifies if communication terminal 200 is connected to a Bluetooth network in step S513. If communication terminal 200 is connected to a Bluetooth network, second control unit 230 identifies if a Bluetooth communication link is set between the communication terminal 200 and PC 100 in step S515. If a Bluetooth communication link is not set between communication terminal 200 and PC 100, second control unit 230 sets a Bluetooth communication link between communication terminal 200 and PC 100 in step S517. Second control unit 230 then controls to display a list of credit cards registered in memory unit 250, as shown in FIG. 7B in step S519.

If a Bluetooth communication link is already set between the communication terminal 200 and PC 100 at step S515, the process continues at step S519.

The user selects a credit card from the list of credit cards in step S521, and second control unit 230 controls to display corresponding credit data, as shown in FIG. 7C in step S523.

If a credit data item is selected from credit data in step S525, second control unit 230 transmits the selected credit data item to PC 100 in step S527. In the case that the selected credit data item is a card number, second control unit 230 may control to input the card number in a format required by PC 100 (for example, XXXX-XXXX-XXXX-XXXX or XXXXXXXXXXXXXXXX).

Second control unit 230 then identifies whether a further credit data item is selected in step S529. If a further credit data item is selected, the process returns to step S527 and second control unit 230 further transmits the selected credit data item to PC 100. Second control unit 230 repeats steps S527 to S529 until all desired credit data items are transmitted.

If communication terminal 200 is not connected to a Bluetooth network at step 513, second control unit 230 identifies if execution of Bluetooth communication is requested in step S531. If execution of Bluetooth communication is requested, second control unit 230 connects communication terminal 200 to a Bluetooth network in step S533 and continues at step S517.

In this exemplary embodiment, Bluetooth communication of second control unit 230 starts when execution of Bluetooth communication is requested after step S511. However, the present invention is not limited thereto and the execution of Bluetooth communication may be executed at any time according to the user's request.

Further, a method of transmitting credit data to PC 100 through a Bluetooth network is described in this exemplary embodiment. However, the present invention is not limited thereto, and any local radio communication means enabling connection between communication terminal 200 and PC 100 may be used.

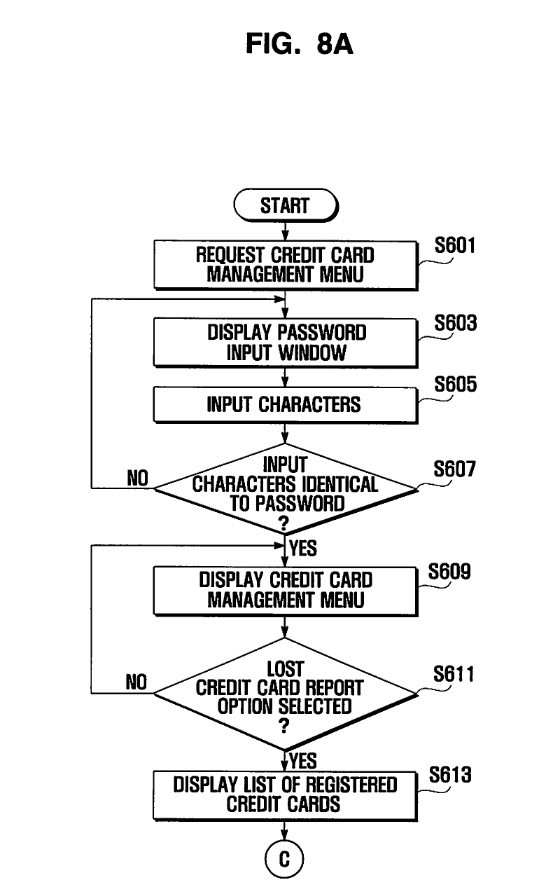

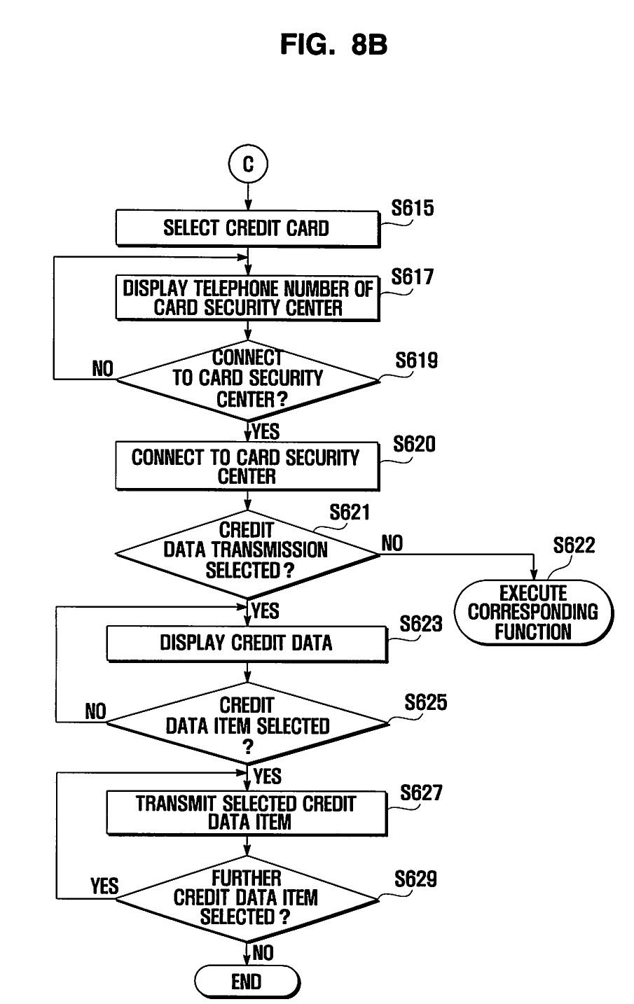

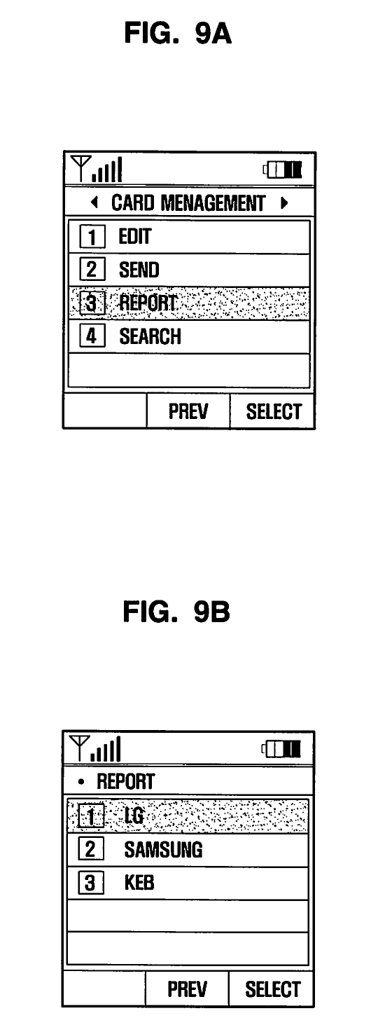

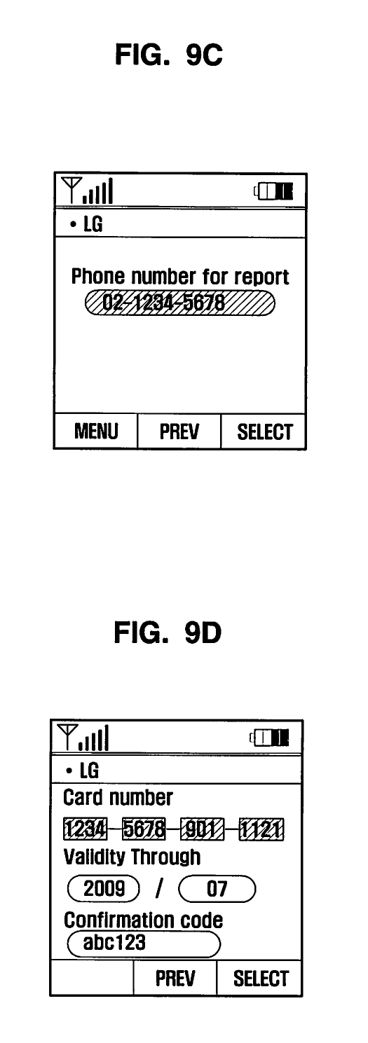

Referring to FIGS. 2, 8A, 8B, and 9A to 9D, the process of reporting a lost credit card starts by inputting a function key (or shortcut key) through second key input unit 270 or by selecting a credit card management option in step S601. Second control unit 230 controls to display a password input window in step S603. Second control unit 230 then receives alphanumeric characters input by a user in step S605 and identifies if the input characters are identical to a registered password in step 607. If the input characters are identical to a registered password, second control unit 230 controls to display a credit card management menu, as shown in FIG. 9A in step S609.

If a lost credit card report option is selected from the credit card management menu in step S611, second control unit 230 controls to display a list of credit cards registered in the memory unit 250, as shown in FIG. 9B in step S613.

The user selects a credit card from the list of credit cards in step S615, and second control unit 230 controls to display a telephone number of a card security center corresponding to the selected credit card, as shown in FIG. 9C in step S617. If connection to a card security center is requested in step S619, second control unit 230 dials the telephone number of the card security center in step S620, and identifies if a credit data transmission is requested by the user in a connection state with the card security center in step S621. If the user does not request a credit data transmission, second control unit 230 performs a requested function in step S622 and terminates the process.

If a credit data transmission is requested by the user in a connection state with the card security center at step S621, second control unit 230 controls to display credit data of the corresponding credit card, as shown in FIG. 9D in step S623. If a credit data item is selected from the credit data in step S625, second control unit 230 transmits the selected credit data item to the card security center in step S627.

Second control unit 230 then identifies whether a further credit data item is selected in step S629. If a further credit data item is selected, the process returns to step S627 and second control unit 230 further transmits the selected credit data item to the card security center. Second control unit 230 repeats steps S627 to S629 until all desired credit data items are transmitted to the card security center.

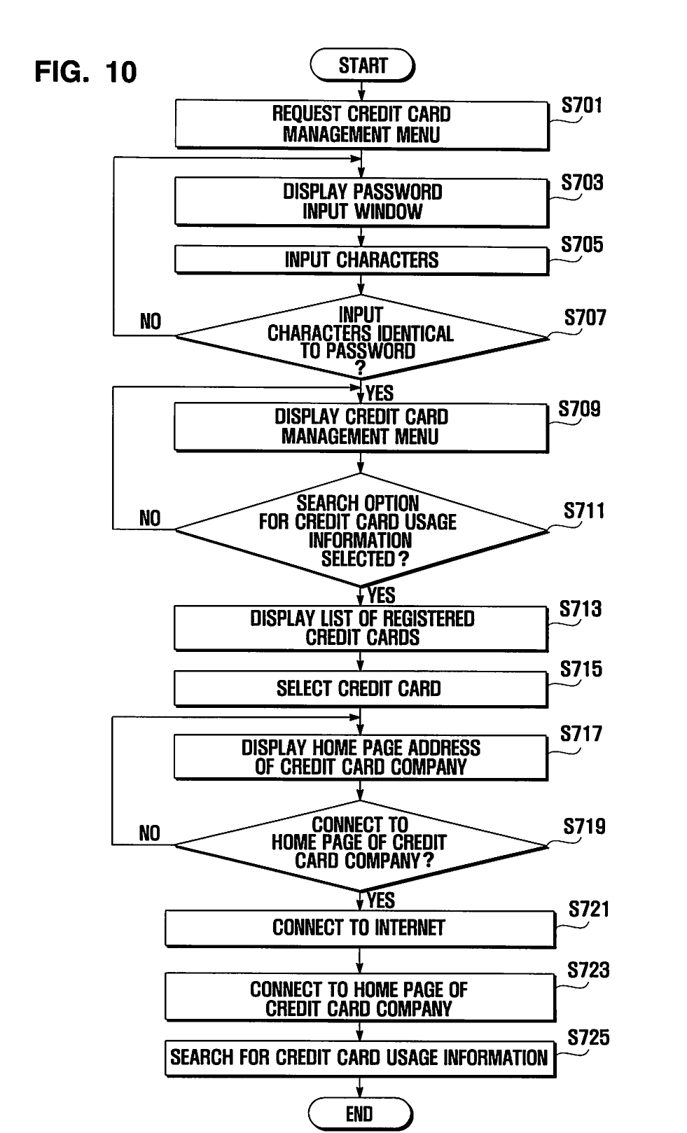

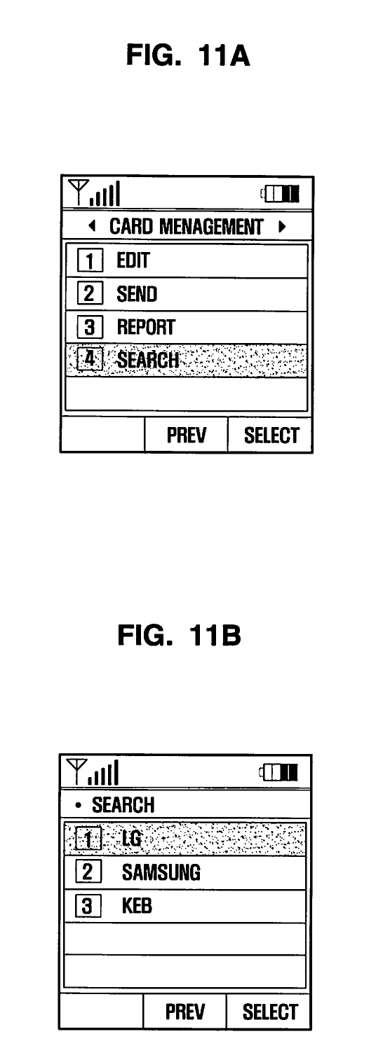

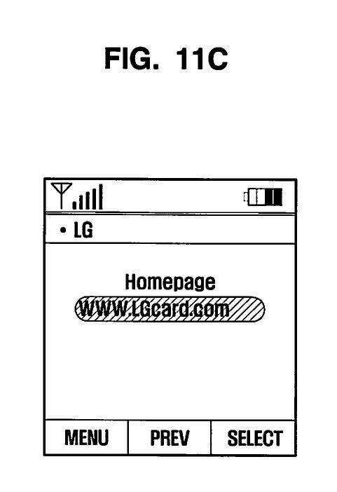

Referring to FIGS. 2, 10, and 11A to 11C, the process of searching for credit card usage information starts by inputting a function key (or shortcut key) through second key input unit 270 or by selecting a credit card management option in step S701. Second control unit 230 controls to display a password input window in step S703. Second control unit 230 then receives alphanumeric characters input by a user in step S705 and identifies if the input characters are identical to a registered password in step S707. If the input characters are identical to a registered password, in step S709, second control unit 230 controls to display a credit card management menu, as shown in FIG. 11A.

If a search option for credit card usage information is selected from the credit card management menu in step S711, in step S713, second control unit 230 controls to display a list of credit cards registered in the memory unit 250, as shown in FIG. 11B.

If a credit card is selected from the list of credit cards by the user in step S715, in step S717, second control unit 230 controls to display a home page address of a credit card company corresponding to the selected credit card, as shown in FIG. 11C. If connection to the home page of the credit card company is requested in step S719, second control unit 230 connects communication terminal 200 to the Internet in step S721 and further to the home page of the credit card company in step S723.

If the connection to the home page of the credit card company succeeds, second control unit 230 searches for the credit card usage information in step S725.

As described above, the credit card management methods using a communication terminal according to the exemplary embodiments of the present invention enables registration and management of a plurality of credit cards owned by a user, and thereby the user of the communication terminal may purchase a commodity easily when purchasing the commodity through the Internet by transmitting credit data through a transaction window of a personal computer. In the case that a credit card is lost or stolen, connection to a card security center and transmission of credit data requested by the card security center may be performed easily. Further, connection to a home page of a credit card company may easily be performed to search for credit card usage information. Therefore, the user of the communication terminal may utilize various functions provided for credit cards owned by the user efficiently.

While the invention has been shown and described with reference to certain preferred embodiments thereof, it will be understood by those skilled in the art that various changes in form and details may be made therein without departing from the spirit and scope of the invention as further defined by the appended claims.

What is claimed is:

1. A method for credit card management using a communication terminal comprising:
displaying a list of registered credit cards, if a credit data transmission is requested;
displaying credit data of the selected credit card, if a credit card is selected from the displayed credit cards; and
transmitting the displayed credit data to a personal computer through a local radio communication network.

2. The method of claim 1, further comprising:
displaying the received credit data in a corresponding input field of a transaction window of the personal computer, if credit data are received by the personal computer; and
transmitting the displayed credit data from the personal computer to a server, if transmission of the displayed credit data is requested.

3. The method of claim 1, wherein the local radio communication network is a Bluetooth network.

4. The method of claim 1, wherein displaying a list of registered credit cards comprises:
identifying whether the request is valid, if a credit data transmission is requested; and
displaying the list of registered credit cards, if the request is valid.

5. A method of credit card management using a communication terminal comprising:
displaying a list of registered credit cards, if a lost credit card report is requested; and
connecting to a card security center to resolve an issue regarding the selected credit card, if a credit card is selected from the displayed list of registered credit cards.

6. The method of claim 5, wherein connecting to a card security center comprises:
displaying credit data of the selected credit card, if a credit data transmission is requested; and
transmitting the displayed credit data to the card security center.

7. The method of claim 6, wherein the displayed credit data is converted to a DTMF dual-tone multi-frequency (DTMF) tone signal prior to the transmission.

8. The method of claim 5, wherein displaying a list of registered credit cards comprises:
identifying whether the request is valid, if a lost credit card report is requested; and
displaying the list of registered credit cards, if the request is valid.

9. A method of a credit card management using a communication terminal comprising:
displaying a list of registered credit cards, if a search for credit card usage information is requested;
connecting to a home page of a credit card company corresponding to the selected credit card, if a credit card is selected from the displayed list of registered credit cards; and
searching for the credit card usage information in the home page of the credit card company.

10. The method of claim 9, wherein displaying a list of registered credit cards comprises:
identifying whether the request is valid, if a search for credit card usage information is requested; and
displaying the list of registered credit card, if the request is correct.

11. A method of credit card management using a communication terminal comprising:
registering a credit card; and
performing the requested function, if a function related to the registered credit card is requested;
wherein performing the requested function comprises transmitting credit data of the registered credit cards to a personal computer through a local radio communication network, if the requested function is a credit data transmission; connecting to a card security center to resolve an issue regarding a selected credit card, if the requested function is a lost credit card report; and searching for the credit card usage information by connecting to a home page of a credit card company corresponding to a selected credit card, if the requested function is a search for credit card usage information.

12. The method of claim 11, wherein performing the requested function comprises:
identifying whether the request is valid, if a function related to the registered credit card is requested; and
performing the requested function, if the request is valid.
